(19) United States
(12) Patent Application Publication
(10) Pub. No.: US 2024/0416893 A1
(43) Pub. Date: Dec. 19, 2024

(54) VEHICLE PLATFORM WITH AUTOMATIC WHEEL CORNER ASSEMBLIES ALIGNING CAPABILITIES

(71) Applicant: REE AUTOMOTIVE LTD, Glil-Yam (IL)

(72) Inventor: Damian Andrew HARTY, Staffordshire (GB)

(73) Assignee: REE AUTOMOTIVE LTD, Glil-Yam (IL)

(21) Appl. No.: 18/703,690

(22) PCT Filed: Oct. 25, 2022
(86) PCT No.: PCT/IL2022/051125

§ 371 Date: Apr. 22, 2024

Related U.S. Application Data
(60) Provisional application No. 63/272,803, filed on Oct. 28, 2021.

(51) Int. Cl. B60W 30/02; B60K 7/00; B60W 10/08; B60W 10/20; B60W 30/18; B62D 5/04

(52) U.S. Cl. CPC B60W 30/02; B60K 7/0007; B60W 10/08; B60W 10/20; B60W 30/18009; B62D 5/0418; B60W 2510/083; B60W 2510/20; B60W 2520/105; B60W 2520/125; B60W 2710/207

(57) ABSTRACT

A method of automatically aligning wheel corner assemblies (WCAs) of a vehicle platform may include: measuring, by sensors of at least one of front WCAs, rear WCAs, a vehicle platform, or any combination thereof, a set of parameters; determining, by a computing device, steering angles for wheels of the front WCAs and wheels of the rear WCAs to drive the vehicle platform in a zero yaw rate and/or a zero thrust angle based on the measured set of parameters; and controlling, by the computing device, steering actuators of the front WCAs and the rear WCAs based on the determined steering angles to drive the vehicle platform in the zero yaw rate and/or the zero thrust angle.

### FIELD OF THE INVENTION

The present invention relates to the field of vehicle wheel alignment, and more particularly, to automatic vehicle wheel alignment.

### BACKGROUND OF THE INVENTION

In order for a vehicle to travel straight and avoid excessive drag on the wheels of the vehicle, the wheels must be aligned with respect to a vehicle platform in a known way. When driving on the road, the tires of the wheels may generate significant lateral forces even for relatively small misalignment angles particularly in a plan (e.g. toe) view of the vehicle platform. Properly aligned wheels may reduce tire wear and/or enhance driving safety of the vehicle.

Vehicle's symmetry plane typically cannot be used as a reference frame for vehicle wheels alignment. For example, locations of attachment points of particular wheels to the vehicle platform may be subject to assembly tolerances and/or may vary in space by, for example, up to 15 mm. The attachment points may change their respective location and/or orientation with respect to the vehicle platform during the service of the vehicle. Most vehicles have means of adjusting location and/or orientation of the wheels, particularly for front wheels. Post-build vehicle wheel alignment may be important for vehicle performance, especially when the vehicle has four or more actuatable (e.g., steering and/or traction) wheels. Absence of a convenient reference frame for vehicle wheels alignment may complicate the post-build wheels alignment procedure.

Vehicle wheel alignment is a standard vehicle maintenance procedure that may include adjusting angles of wheels according to predefined specifications. Typically, wheel alignment procedures require dedicated wheel alignment systems. Such systems are typically installed in automobile workshop facilities, and may be bulky, expensive and can be operated by skilled staff only.

### SUMMARY OF THE INVENTION

Some embodiments of the present invention may provide a method of automatically aligning wheel corner assemblies (WCAs) of a vehicle platform, the method may include: measuring, by sensors of at least one of front WCAs, rear WCAs, a vehicle platform, or any combination thereof, a set of parameters; determining, by a computing device, steering angles for wheels of the front WCAs and wheels of the rear WCAs to drive the vehicle platform in at least one of a zero yaw rate or a zero thrust angle based on the measured set of parameters; and controlling, by the computing device, steering actuators of the front WCAs and the rear WCAs based on the determined steering angles to drive the vehicle platform in at least one of the zero yaw rate or the zero thrust angle.

Some embodiments may include controlling, by the computing device, the steering actuators associated with at least one of the front WCAs or the rear WCAs of the vehicle platform to steer their respective wheels according to a predefined protocol.

In some embodiments, determining the steering angles to drive the vehicle platform in the zero yaw rate includes: controlling, by the computing device, drivetrain motors associated with the front WCAs of the vehicle platform to accelerate the vehicle platform to a predefined speed; controlling, by the computing device, the steering actuators associated with the front WCAs to steer the wheels of the front WCAs within a predefined steering angles range; measuring (e.g. by wheel hub rotation sensors) rotational speeds of the wheels of the rear WCAs; determining, by the computing device, steering angles of the wheels of the front WCAs for which the wheels of the rear WCAs rotate at the same rotational speed with respect to each other based on the measured rotational speeds; and controlling, by the computing device, the steering actuators associated with the front WCAs based on the determined steering angles to drive the vehicle platform in the zero yaw rate.

Some embodiments may include disabling, by the computing device, a zero yaw rate control sub-functionality of a toe control functionality of the vehicle platform.

Some embodiments may include controlling, by the computing device, the steering actuators to simultaneously steer the wheels of the front WCAs in the same direction.

Some embodiments may include: determining, by the computing device, steering angles of at least one of the wheels of the front WCAs or the wheels of the rear WCAs for which a thrust angle of the front WCAs and a thrust angle of the rear WCAs being aligned with respect to each other; and controlling, by the computing device, the steering actuators associated with at least one of the front WCAs or the rear WCAs based on the determined steering angles to align the thrust angle of the front WCAs and the thrust angle of the rear WCAs.

In some embodiments, determining the steering angles to align the thrust angle of the front WCAs and the thrust angle of the rear WCAs with respect to each other may include: controlling, by the computing device, drivetrain motors associated with at least one of the front WCAs or the rear WCAs to accelerate the vehicle platform to a predefined speed; controlling, by the computing device, the steering actuators associated with the front WCAs to steer the wheels of the front WCAs to drive the vehicle platform in the zero yaw rate; controlling, by the computing device, the steering actuators associated with the rear WCAs to steer the wheels of the rear WCAs in a predefined steering angles range; measuring, by torque sensors, first torque values being applied by the drivetrain motors; determining, by the computing device, first steering angles for the wheels of the rear WCAs that cause the drivetrain motors to apply minimal torque values of the measured first torque values; determining, by the computing device, a thrust angle of the rear WCAs based on the determined first steering angles.

Some embodiments may include controlling, by the computing device, the steering actuators associated with the rear WCAs to simultaneously steer the wheels of the rear WCAs in opposite directions with respect to each other.

Some embodiments may include: controlling, by the computing device, the steering actuators associated with the rear WCAs to steer the wheels of the rear WCAs to drive the vehicle platform in the zero yaw rate; controlling, by the computing device, the steering actuators associated with the front WCAs to steer the wheels of the second WCAs in the predefined steering angles range; measuring, by torque sensors, second torque values being applied by the drivetrain motors; determining, by the computing device, second steering angles for the wheels of the front WCAs that cause the drivetrain motors to apply minimal torque values of the measured second torque values; determining, by the computing device, a thrust angle of the rear WCAs based on the determined second steering angles; and controlling, by the computing device, the steering actuators associated with at least one of the front WCAs or the rear WCAs to steer their respective wheels to align the thrust angle of the front WCAs and the thrust angle of the rear WCAs with respect to each other.

Some embodiments may include controlling, by the computing device, the steering actuators associated with the front WCAs to simultaneously steer the wheels of the front WCAs in opposite directions with respect to each other.

In some embodiments, determining the steering angles to drive the vehicle platform in the zero thrust angle may include: controlling, by the computing device, drivetrain motors associated with at least one of the front WCAs or the rear WCAs to accelerate the vehicle platform to a predefined speed; controlling, by the computing device, the steering actuators associated with the front WCAs and the rear WCAs to steer the wheels of the front WCAs and the rear WCAs to drive the vehicle platform in the zero yaw rate; controlling, by the computing device, the steering actuators associated with the front WCAs and the rear WCAs to steer their respective wheels in a first direction by a first steering angle value; controlling, by the computing device, the drivetrain motors associated with at least one of the front WCAs or the rear WCAs to subsequently accelerate and decelerate the vehicle platform when the vehicle platform being steered in the first direction; controlling, by the computing device, the steering actuators associated with the front WCAs and the rear WCAs to steer their respective wheels in a second direction by a second steering angle value; controlling, by the computing device, the drivetrain motors associated with at least one of the front WCAs or the rear WCAs to subsequently accelerate and decelerate the vehicle platform when the vehicle platform being steered in the first direction; measuring, by an accelerometer sensor, a set of acceleration values of the vehicle platform; determining, by the computing device, steering angles of the wheels of the front WCAs and the wheels of the rear WCAs to drive the vehicle platform in the zero thrust angle based on the measured set of acceleration values; and controlling, by the computing device, the steering actuators associated with the front WCAs and the rear WCAs based on the determined steering angles to drive the vehicle platform in the zero thrust angle.

Some embodiments may include: measuring, by steering angle sensors, steering angles of the front WCAs and the rear WCAs when the vehicle platform is at the predefined speed and when the front WCAs and the rear WCAs being toe controlled by the computing device; determining, by the computing device, mean steering angles values based on the measured steering angle values; and determining, by the computing device, the first steering angle value and the second steering angle value based on the mean steering angles values.

In some embodiments, the measured acceleration values comprise lateral acceleration values.

In some embodiments, the computing device is disposed on the vehicle platform.

Some embodiments of the present invention may provide a method of automatically aligning wheel corner assemblies (WCAs) of a vehicle platform, the method may include: controlling, by a computing device, steering actuators associated with at least one of front WCAs or rear WCAs of a vehicle platform to steer their respective wheels to drive the vehicle platform in a zero yaw rate; determining, by the computing device, first steering angles of the wheels of the rear WCAs to steer the wheels of the rear WCAs to rotate in planes that are parallel with respect to each other; determining, by the computing device, a thrust angle of the rear WCAs based on the determined first steering angles; determining, by the computing device, second steering angles of the wheels of the front WCAs to steer the wheels of the front WCAs to rotate in planes that are parallel with respect to each other; determining, by the computing device, a thrust angle of the front WCAs based on the determined second steering angles; controlling, by the computing device, the steering actuators associated with at least one of the front WCAs or the rear WCAs to steer their respective wheels to align the thrust angle of the front WCAs and the thrust angle of the rear WCAs with respect to each other; determining, by the computing device, third steering angles of the wheels of the front WCAs and the wheels of the rear WCAs to drive the vehicle platform in a zero thrust angle; and controlling, by the computing device, the steering actuators associated with at least one of the front WCAs or the rear WCAs based on the determined third steering angles to drive the vehicle platform in the zero thrust angle.

Some embodiments may include determining steering angles of at least one of the wheels of the front WCAs or the wheels of the rear WCAs to drive the vehicle platform in the zero yaw rate.

In some embodiments, determining the steering angles to drive the vehicle platform in the zero yaw rate may include: controlling, by the computing device, drivetrain motors associated with the front WCAs of the vehicle platform to accelerate the vehicle platform to a predefined speed; controlling, by the computing device, the steering actuators associated with the front WCAs to steer the wheels of the front WCAs within a predefined steering angles range; measuring (e.g. by wheel hub rotation sensors) rotational speeds of the wheels of the rear WCAs; determining, by the computing device, the steering angles of the wheels of the front WCAs for which the wheels of the rear WCAs rotate at the same rotational speed with respect to each other based on the measured rotational speeds; and controlling, by the computing device, the steering actuators associated with the front WCAs based on the determined steering angles to drive the vehicle platform in the zero yaw rate.

Some embodiments may include disabling, by the computing device, a zero yaw rate control sub-functionality of a toe control functionality of the vehicle platform.

Some embodiments may include controlling, by the computing device, the steering actuators to simultaneously steer the wheels of the front WCAs in the same direction.

In some embodiments, determining the first steering angles to steer the wheels of the front WCAs to rotate in planes that are parallel with respect to each other may include: controlling, by the computing device, drivetrain motors associated with at least one of the front WCAs or the rear WCAs to accelerate the vehicle platform to a predefined speed; controlling, by the computing device, the steering actuators associated with the front WCAs to steer the wheels of the front WCAs to drive the vehicle platform in the zero yaw rate; controlling, by the computing device, the steering actuators associated with the rear WCAs to steer the wheels of the rear WCAs in a predefined steering angles range; measuring, by torque sensors, first torque values being applied by the drivetrain motors; determining, by the computing device, first steering angles for the wheels of the rear WCAs that cause the drivetrain motors to apply minimal torque values of the measured first torque values; determining, by the computing device, a thrust angle of the rear WCAs based on the determined first steering angles.

Some embodiments may include controlling, by the computing device, the steering actuators associated with the rear WCAs to simultaneously steer the wheels of the rear WCAs in opposite directions with respect to each other.

In some embodiments, determining the second steering angles to steer the wheels of the rear WCAs to rotate in planes that are parallel with respect to each other may include: controlling, by the computing device, the steering actuators associated with the rear WCAs to steer the wheels of the rear WCAs to drive the vehicle platform in the zero yaw rate; controlling, by the computing device, the steering actuators associated with the front WCAs to steer the wheels of the second WCAs in the predefined steering angles range; measuring, by torque sensors, second torque values being applied by the drivetrain motors; determining, by the computing device, the second steering angles for the wheels of the front WCAs second steering angles for the wheels of the front WCAs that cause the drivetrain motors to apply minimal torque values of the measured second torque values; determining, by the computing device, a thrust angle of the rear WCAs based on the determined second steering angles; and controlling, by the computing device, the steering actuators associated with at least one of the front WCAs or the rear WCAs to steer their respective wheels to align the thrust angle of the front WCAs and the thrust angle of the rear WCAs with respect to each other.

Some embodiments may include controlling, by the computing device, the steering actuators associated with the front WCAs to simultaneously steer the wheels of the front WCAs in opposite directions with respect to each other.

In some embodiments, determining the third steering angles to drive the vehicle platform in the zero thrust angle may include: controlling, by the computing device, drivetrain motors associated with at least one of the front WCAs or the rear WCAs to accelerate the vehicle platform to a predefined speed; controlling, by the computing device, the steering actuators associated with the front WCAs and the rear WCAs to steer the wheels of the front WCAs and the rear WCAs to drive the vehicle platform in the zero yaw rate based on a toe control functionality of the computing unit; controlling, by the computing device, the steering actuators associated with the front WCAs and the rear WCAs to steer their respective wheels in a first direction by a first steering angle value; controlling, by the computing device, the drivetrain motors associated with at least one of the front WCAs or the rear WCAs to subsequently accelerate and decelerate the vehicle platform when the vehicle platform being steered in the first direction; controlling, by the computing device, the steering actuators associated with the front WCAs and the rear WCAs to steer their respective wheels in a second direction by a second steering angle value; controlling, by the computing device, the drivetrain motors associated with at least one of the front WCAs or the rear WCAs to subsequently accelerate and decelerate the vehicle platform when the vehicle platform being steered in the first direction; measuring, by an accelerometer sensor, a set of acceleration values of the vehicle platform; determining, by the computing device, the third steering angles of the wheels of the front WCAs and the wheels of the rear WCAs to drive the vehicle platform in the zero thrust angle based on the measured set of acceleration values; and controlling, by the computing device, the steering actuators associated with the front WCAs and the rear WCAs based on the determined third steering angles to drive the vehicle platform in the zero thrust angle.

Some embodiments may include: measuring, by steering angle sensors, steering angles of the front WCAs and the rear WCAs when the vehicle platform is at the predefined speed and when the front WCAs and the rear WCAs being toe controlled by the computing device; determining, by the computing device, mean steering angles values based on the measured yaw/steering angle values; and determining, by the computing device, the first steering angle value and the second steering angle value based on the mean steering angles values.

In some embodiments, the measured acceleration values comprise lateral acceleration values.

In some embodiments, the computing device is disposed on the vehicle platform.

Some embodiments of the present invention may provide a method of automatically aligning wheel corner assemblies (WCAs) of a vehicle platform to drive the vehicle platform in a zero yaw rate, the method may include: controlling, by a computing device, drivetrain motors associated with front WCAs of the vehicle platform to accelerate the vehicle platform to a predefined speed; controlling, by the computing device, the steering actuators associated with the front WCAs to steer the wheels of the front WCAs within a predefined steering angles range; measuring (e.g. by wheel hub rotation sensors) rotational speeds of the wheels of the rear WCAs; and determining, by the computing device, steering angles of the wheels of the front WCAs for which the wheels of rear WCAs of the vehicle platform rotate at the same rotational speed with respect to each other based on the measured rotational speeds; and controlling, by the computing device, the steering actuators associated with the front WCAs based on the determined steering angles to drive the vehicle platform in the zero yaw rate.

Some embodiments may include disabling, by the computing device, a zero yaw rate control sub-functionality of a toe control functionality of the vehicle platform.

Some embodiments may include controlling, by the computing device, the steering actuators to simultaneously steer the wheels of the front WCAs in the same direction.

In some embodiments, the computing device is disposed on the vehicle platform.

Some embodiments of the present invention may provide a method of automatically aligning a thrust angle of front wheel corner assemblies (WCAs) with a thrust angle of rear WCAs of a vehicle platform, the method may include: controlling, by a computing device, drivetrain motors associated with front WCAs and/or rear WCAs of a vehicle platform to accelerate the vehicle platform to a predefined speed; controlling, by the computing device, steering actuators associated with the front WCAs to steer the wheels of the front WCAs to drive the vehicle platform in a zero yaw rate; controlling, by the computing device, steering actuators associated with the rear WCAs to steer the wheels of the rear WCAs in a predefined steering angles range; measuring, by torque sensors, first torque values being applied by the drivetrain motors; determining, by the computing device, first steering angles for the wheels of the rear WCAs that cause the drivetrain motors to apply minimal torque values of the measured first torque values; determining, by the computing device, a thrust angle of the rear WCAs based on the determined first steering angles; controlling, by the computing device, the steering actuators associated with the rear WCAs to steer the wheels of the rear WCAs to drive the vehicle platform in the zero yaw rate; controlling, by the computing device, the steering actuators associated with the front WCAs to steer the wheels of the second WCAs in the predefined steering angles range; measuring, by torque sensors, second torque values being applied by the drivetrain motors; determining, by the computing device, second steering angles for the wheels of the front WCAs second steering angles for the wheels of the front WCAs that cause the drivetrain motors to apply minimal torque values of the measured second torque values; determining, by the computing device, a thrust angle of the rear WCAs based on the determined second steering angles; and controlling, by the computing device, the steering actuators associated with at least one of the front WCAs or the rear WCAs to steer their respective wheels to align the thrust angle of the front WCAs and the thrust angle of the rear WCAs with respect to each other.

In some embodiments, the computing device is disposed on the vehicle platform.

Some embodiments of the present invention may provide a method of automatically aligning wheel corner assemblies (WCAs) of a vehicle platform to drive the vehicle platform in a zero thrust angle, the method may include: controlling, by a computing device, drivetrain motors associated with at least one of front WCAs or rear WCAs of a vehicle platform to accelerate the vehicle platform to a predefined speed; controlling, by the computing device, steering actuators associated with the front WCAs and the rear WCAs to steer the wheels of the front WCAs and the rear WCAs to drive the vehicle platform in the zero yaw rate based on a toe control functionality of the computing unit; controlling, by the computing device, the steering actuators associated with the front WCAs and the rear WCAs to steer their respective wheels in a first direction by a first steering angle value; controlling, by the computing device, the drivetrain motors associated with at least one of the front WCAs or the rear WCAs to subsequently accelerate and decelerate the vehicle platform when the vehicle platform being steered in the first direction; controlling, by the computing device, the steering actuators associated with the front WCAs and the rear WCAs to steer their respective wheels in a second direction by a second steering angle value; controlling, by the computing device, the drivetrain motors associated with at least one of the front WCAs or the rear WCAs to subsequently accelerate and decelerate the vehicle platform when the vehicle platform being steered in the first direction; measuring, by an accelerometer sensor, a set of acceleration values of the vehicle platform; determining, by the computing device, steering angles of the wheels of the front WCAs and the wheels of the rear WCAs to drive the vehicle platform in the zero thrust angle based on the measured set of acceleration values; and controlling, by the computing device, the steering actuators of the front WCAs and the rear WCAs based on the determined steering angles to drive the vehicle platform in the zero thrust angle.

Some embodiments may include: measuring, by yaw/steering angle sensors, steering angles of the front WCAs and the rear WCAs when the vehicle platform is at the predefined speed and when the front WCAs and the rear WCAs being toe controlled by the computing device; determining, by the computing device, mean yaw/steering angles values based on the measured yaw/steering angle values; and determining, by the computing device, the first steering angle value and the second steering angle value based on the mean yaw/steering angles values.

In some embodiments, the measured acceleration values comprise lateral acceleration values.

In some embodiments, the computing device is disposed on the vehicle platform.

### BRIEF DESCRIPTION OF THE DRAWINGS

For a better understanding of embodiments of the invention and to show how the same can be carried into effect, reference will now be made, purely by way of example, to the accompanying drawings in which like numerals designate corresponding elements or sections throughout.

In the accompanying drawings:

FIGS. 1A, 1B, 1C and 1D are schematic illustrations of a vehicle platform, according to some embodiments of the invention;

FIG. 2 is a flowchart of a method of automatically aligning wheel corner assemblies (WCAs) of a vehicle platform, according to some embodiments of the invention;

FIG. 3A is a flowchart of a method of automatically aligning WCAs of a vehicle platform to drive the vehicle platform in a zero yaw rate, according to some embodiments of the invention;

FIG. 3B shows a graph of experimental results of utilizing the method of automatically aligning the WCAs of the vehicle platform to drive the vehicle platform in the zero yaw rate, according to some embodiments of the invention;

FIG. 3C shows schematic illustrations of the vehicle platform exhibiting a non-zero yaw rate and a zero yaw rate, according to some embodiments of the invention;

FIG. 4A is a flowchart of a method of automatically aligning a thrust angle of front WCAs with a thrust angle of rear WCAs of a vehicle platform, according to some embodiments of the invention;

FIGS. 4B and 4C show graphs of experimental results of utilizing the method of automatically aligning the thrust angle of front WCAs with the thrust angle of rear WCAs of the vehicle platform, according to some embodiments of the invention;

FIG. 4D shows schematic illustrations of the vehicle platform exhibiting misaligned front and rear WCAs thrust angles and aligned front and rear WCAs thrust angles, according to some embodiments of the invention;

FIG. 5A is a flowchart of a method of automatically aligning WCAs of a vehicle platform to drive the vehicle platform in a zero thrust angle, according to some embodiments of the invention;

FIG. 5B shows a graph of experimental results of utilizing the method of automatically aligning the WCAs of the vehicle platform to drive the vehicle platform in the zero thrust angle, according to some embodiments of the invention;

FIG. 5C shows schematic illustrations of the vehicle platform exhibiting a non-zero thrust angle and a zero thrust angle, according to some embodiments of the invention; and

FIG. 6 is a block diagram of an exemplary computing device which may be used with embodiments of the present invention.

It will be appreciated that, for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE INVENTION

In the following description, various aspects of the present invention are described. For purposes of explanation, specific configurations and details are set forth in order to provide a thorough understanding of the present invention. However, it will also be apparent to one skilled in the art that the present invention can be practiced without the specific details presented herein. Furthermore, well known features can have been omitted or simplified in order not to obscure the present invention. With specific reference to the drawings, it is stressed that the particulars shown are by way of example and for purposes of illustrative discussion of the present invention only and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention can be embodied in practice.

Before at least one embodiment of the invention is explained in detail, it is to be understood that the invention is not limited in its application to the details of construction and the arrangement of the components set forth in the following description or illustrated in the drawings. The invention is applicable to other embodiments that can be practiced or carried out in various ways as well as to combinations of the disclosed embodiments. Also, it is to be understood that the phraseology and terminology employed herein is for the purpose of description and should not be regarded as limiting.

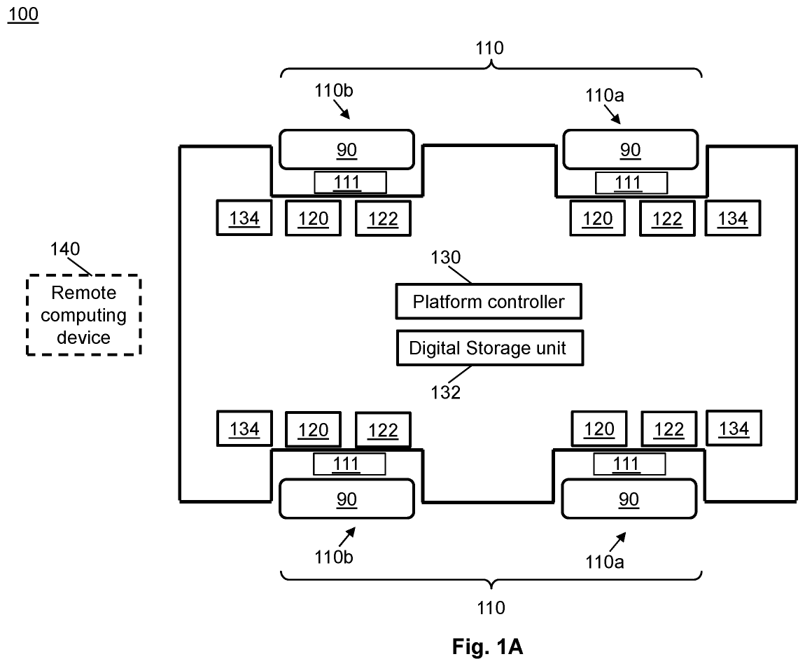

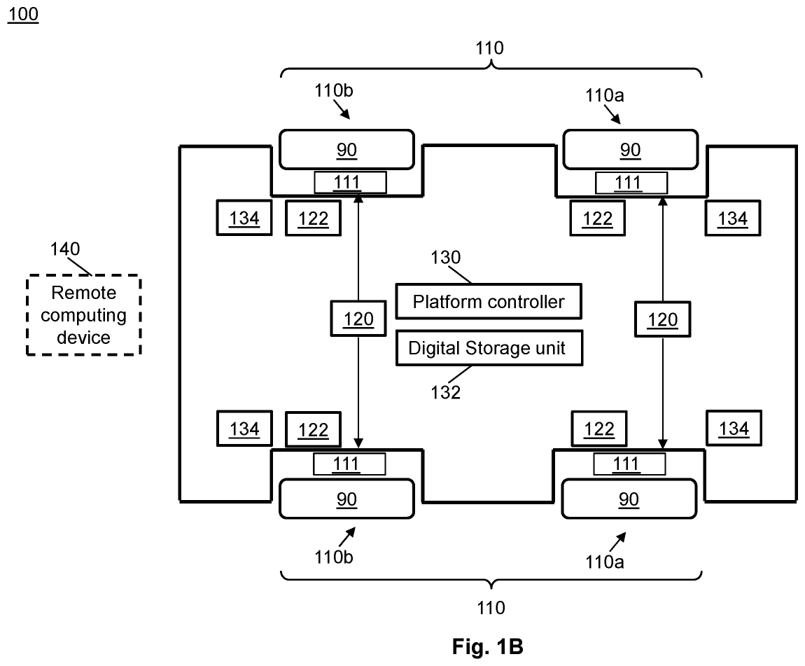

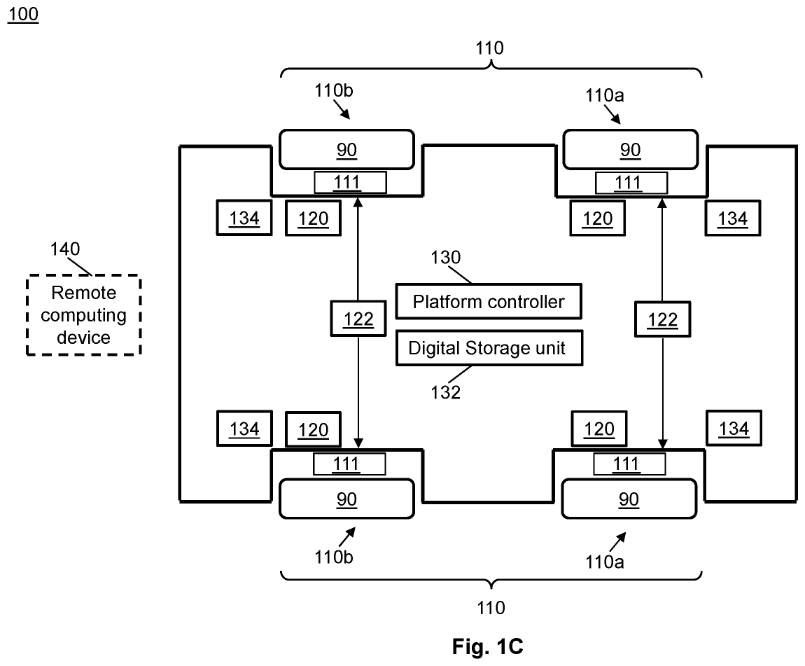

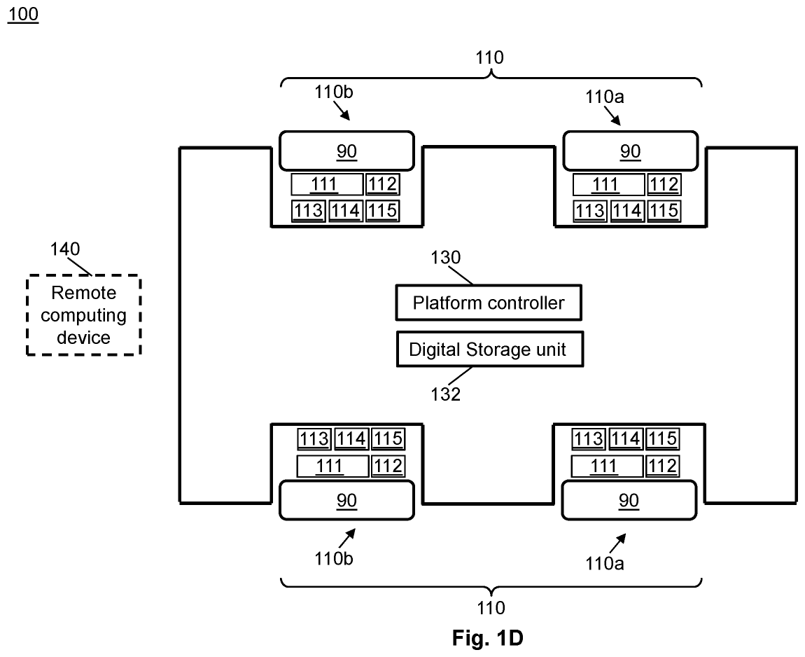

Reference is now made to FIGS. 1A, 1B, 1C and 1D, which are schematic illustrations of a vehicle platform 100, according to some embodiments of the invention.

According to some embodiments of the invention, vehicle platform 100 includes at least four (4) wheel corner assemblies (WCAs) 110. For example, vehicle platform 100 may include two front WCAs 110a and two rear WCAs 110b (e.g., as shown in FIGS. 1A, 1B and 1C). Vehicle platform 100 may include at least four (4) wheels 90 each being assembled to one of WCAs 110. For example, each of wheels 90 may be assembled to a wheel hub or a knuckle of one of WCAs 110. In some embodiments, each of WCAs 110 includes a suspension unit 111.

WCAs 110 may be steerable WCAs. In some embodiments, vehicle platform 100 includes one or more platform steering actuators 120 to steer wheels 90 of WCAs 110. For example, each of platform steering actuators 120 may steer one of WCAs 110 (e.g., as shown in FIG. 1A). In another example, one of platform steering actuators 120 may steer one of front WCAs 110a or rear WCAs 110b (e.g., as shown in FIG. 1B). In some embodiments, each of WCAs 110 includes a WCA steering actuator 112 to steer its respective wheel 90 (e.g., as shown in FIG. 1D). In various embodiments, two of WCAs 110 (e.g., front WCAs 110a or rear WCAs 110b) being steered by WCA steering actuators 112 (e.g., as shown in FIG. 1D) and other two WCAs 110 being driven by two platform steering actuators 120 (e.g., as shown in FIGS. 1A and 1C) or by single steering actuator 120 (e.g., as shown in FIG. 1B).

At least two of WCAs 110 may be driving WCAs. For example, front WCAs 110a, rear WCAs 110b or both may be driving WCAs. In some embodiments, vehicle platform 100 includes one or more platform drivetrain motors 122 to drive wheels 90 of WCAs 110. For example, each of platform drivetrain motors 122 may drive one of WCAs 110 (e.g., as shown in FIG. 1A). In another example, one of platform drivetrain motors 122 may drive one of front WCAs 110a or rear WCAs 110b (e.g., as shown in FIG. 1B). In some embodiments, each of WCAs 110 includes a WCA drivetrain motor 113 to drive its respective wheel 90 (e.g., as shown in FIG. 1D). In various embodiments, two of WCAs 110 (e.g., front WCAs 110a or rear WCAs 110b) being driven by WCA drivetrain motors 113 (e.g., as shown in FIG. 1D) and other two WCAs 110 being driven by two platform drivetrain motors 122 (e.g., as shown in FIGS. 1A and 1B) or by single drivetrain motor 122 (e.g., as shown in FIG. 1C).

In some embodiments, each of WCAs 110 includes a controller 114 (e.g., as shown in FIG. 1C). WCA controllers 114 may control components of their respective WCAs. For example, WCA controllers 114 may control WCA steering actuators 112 and/or WCA drivetrain motors 113 of their respective WCAs 110. In some embodiments, each of WCAs 110 includes a WCA digital storage unit 115 (e.g., as shown in FIG. 1C). WCA digital storage units 115 may store digital data (e.g., executable sets of instructions, digital data from sensors or any other digital data). In some embodiments, each of WCAs 110 includes WCA sensors 115 (e.g., as shown in FIG. 1C). WCA sensors 115 may, for example, include wheel hub rotation sensors, drivetrain torque sensors, yaw/steering angle sensors and/or any other sensors known in the art.

In some embodiments, vehicle platform 100 includes a platform controller 130 (e.g., as shown in FIGS. 1A, 1B and 1C). In various embodiments, platform controller 130 controls platform steering actuators 120 and/or platform drivetrain motors 122. In various embodiments, platform controller 130 controls WCA steering actuators 112 and/or WCA drivetrain motors 113 of WCAs 110, directly and/or via WCA controllers 114. In some embodiments, vehicle platform 100 includes a platform digital storage unit 132 to store digital data (e.g., executable sets of instructions, digital data from sensors or any other digital data). In some embodiments, vehicle platform 100 includes platform sensors 134. Platform sensors 134 may, for example, include drivetrain torque sensors and yaw rate sensors. Platform sensors 134 may also include other sensors.

In various embodiments, a remote computing device 140 controls at least one of components of vehicle platform 100 or components of WCAs 110. Remote computing device 140 may, for example, control platform steering actuators 120 and/or platform drivetrain motors 122, directly and/or via platform controller 130. In another example, remote computing device 140 may control WCA steering actuators 112 and/or WCA drivetrain motors 113, directly and/or via WCA controllers 114 and/or via platform controller 130.

In some embodiments, at least one of WCA controllers 114, platform controller 130, remote computing device 140, or any combination thereof, includes a toe control functionality. The toe control functionality may determine steering angles and/or to control at least one of WCA steering actuators 112 or platform steering actuators 120 as described hereinbelow. For example, the toe control functionality may execute sets of instructions to determine steering angle and/or to control WCA steering actuators 112 and/or platform steering actuators 120.

In some embodiments, at least one of WCA controllers 114, platform controller 130, remote computing device 140, or any combination thereof, includes a torque control functionality to control at least one of WCA drivetrain motors 113 or platform drivetrain motors 122. The torque control functionality may, for example, execute sets of instructions to control WCA drivetrain motors 113 and/or platform drivetrain motors 122.

According to some embodiments of the present invention, vehicle platform 100 automatically aligns its WCAs 110 in one or more rides on a flat (or substantially flat) surface. For example, a computing device such as one or more WCA controllers 114, platform controller 130, remote computing device 140, or any combination thereof, may cause components of vehicle platform 100 to perform one or more series of functions to automatically align WCAs 110 of vehicle platform 110. For example, one or more WCA digital storage units 115, platform digital storage unit 132, a remote digital storage unit, or any combination thereof, may store executable sets of instructions that when executed cause the computing device to perform one or series of functions to automatically align WCAs 110 of vehicle platform 100.

The computing device may control steering actuators (e.g., either steering actuators 120 and/or steering actuators 112) and drivetrain motors (e.g., either drivetrain motors 122 and/or drivetrain motors 113) to steer the wheels of WCAs 110 and to alternately accelerate and decelerate vehicle platform 100 according to a predefined protocol.

The computing device may receive a set of parameters being measured by WCA sensors 115 and/or by platform sensors 134. The set of parameters may, for example, include steering angles, steering rates, steering torques, resistance to steering, toe angles, wheel rotation torque, vehicle drive direction, yaw rates, vehicle drag rates or any other suitable parameter.

The computing device may determine steering angles for the wheels of front WCAs 110a and/or the wheels of rear WCAs 110b to drive vehicle platform 100 in a zero yaw rate and/or a zero thrust angle based on the measured set of parameters (e.g., as described hereinbelow).

The computing device may control the steering actuators (e.g., either platform steering actuators 120 and/or WCA steering actuators 112) based on the determined steering angles to drive the vehicle platform in the zero yaw rate and/or the zero thrust angle.

The following flowcharts, illustrations and description provide examples for methods that may be implemented by a computing device (e.g., one or more WCA controllers 114, platform controller 130, remote computing device 140, or any combination thereof) to automatically align various angles of WCAs of the vehicle platform (e.g., WCAs 110 of vehicle platform 100). It is noted that various combinations of embodiments described below are possible.

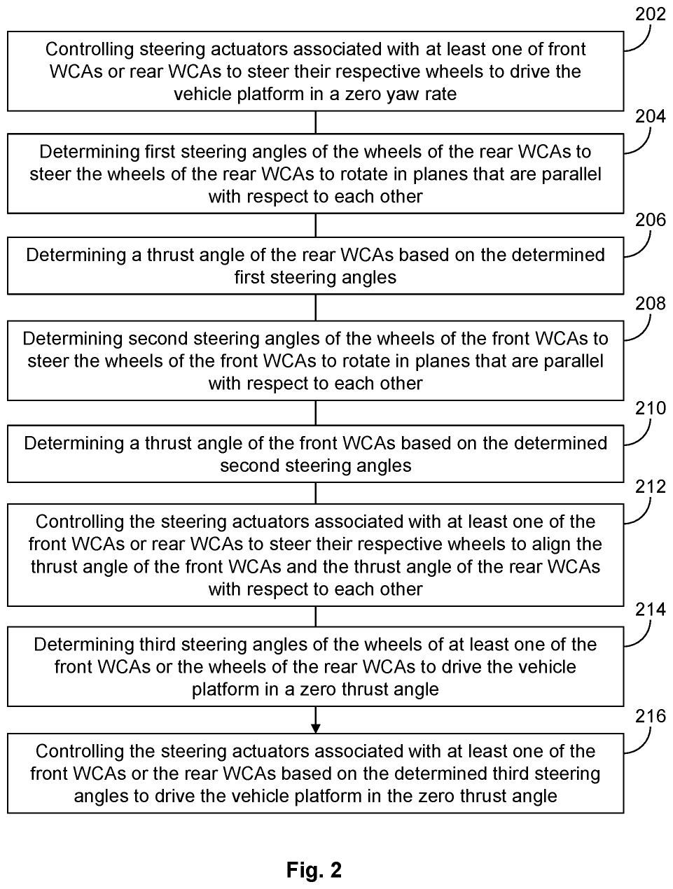

Reference is now made to FIG. 2, which is a flowchart of a method of automatically aligning WCAs of a vehicle platform, according to some embodiments of the invention.

The method may be preformed by, for example, one or more of WCA controllers 114, platform controller 130, remote computing device 140, or any combination thereof, as described hereinabove with respect to FIGS. 1A, 1B, 1C and 1D.

The method may include controlling 202 steering actuators associated with at least one of front WCAs or rear WCAs to steer their respective wheels to drive the vehicle platform in a zero yaw rate. For example, the vehicle platform may be vehicle platform 100; the front WCAs may be front WCAs 110a; the rear WCAs may be rear WCAs 110b; the steering actuators may be WCA steering actuators 112, platform steering actuators 120, or any combination thereof as described hereinabove.

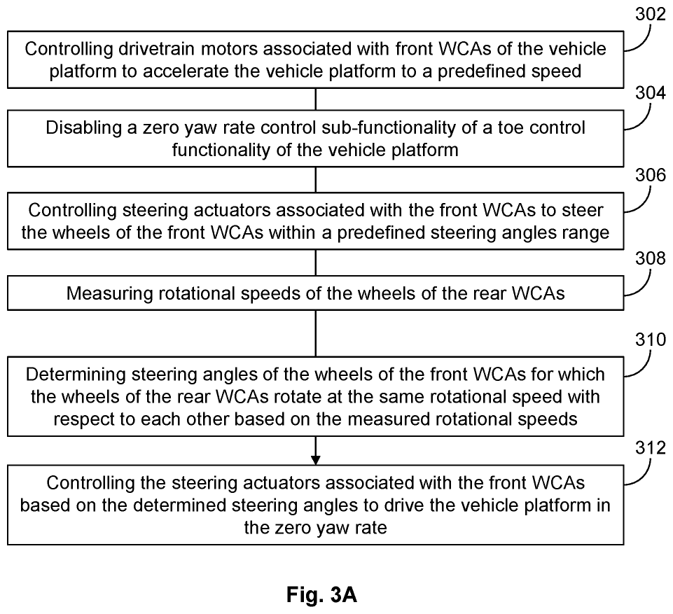

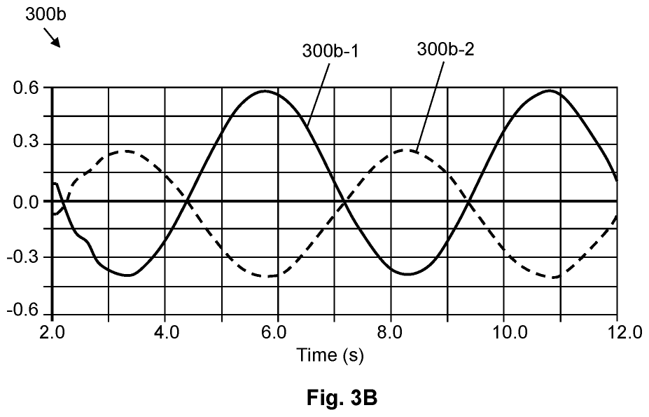

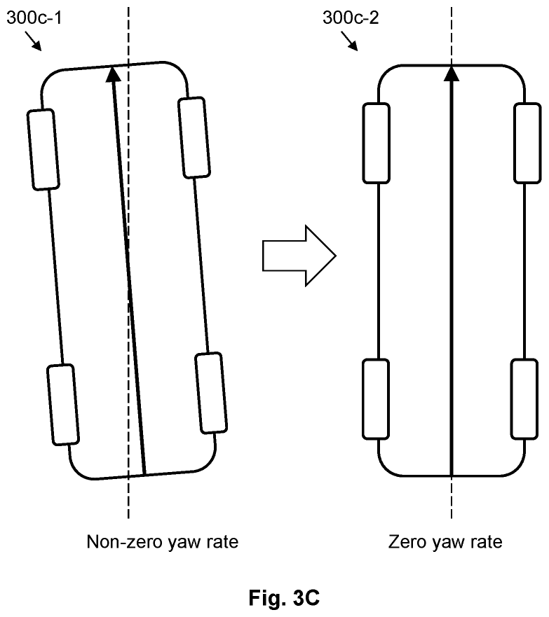

In some embodiments, the zero yaw rate may be known. Some embodiments may include determining, by the computing device, steering angles of at least one of wheels of the front WCAs or wheels of the rear WCAs to drive the vehicle platform in the zero yaw rate (e.g., as described hereinbelow with respect to FIGS. 3A, 3B and 3C).

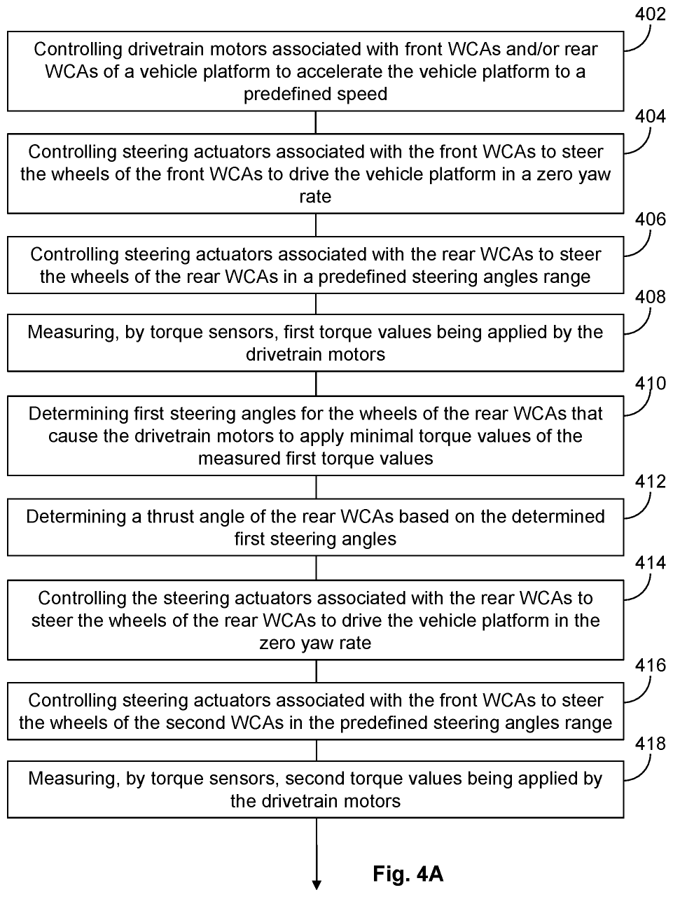

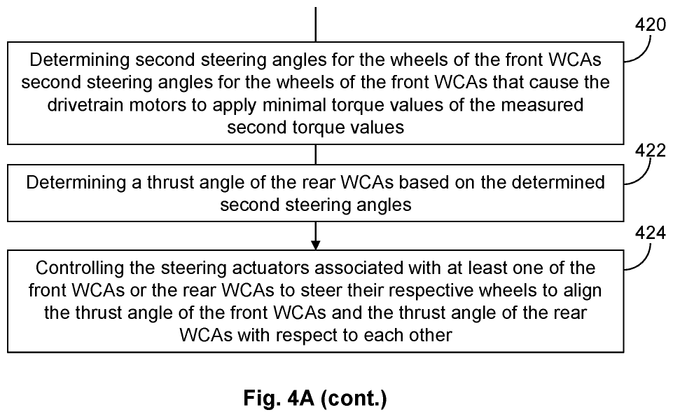

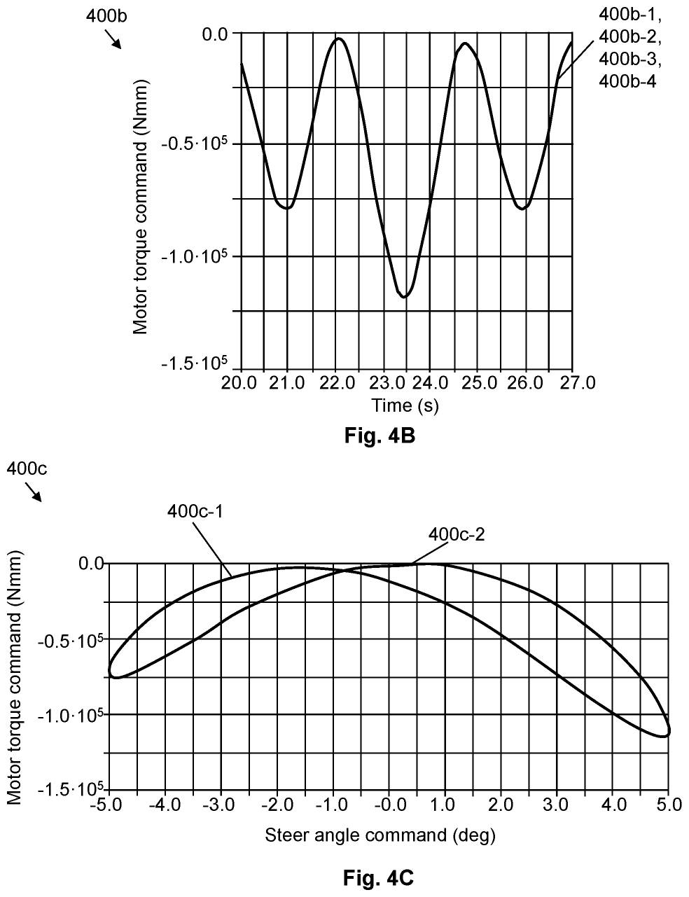

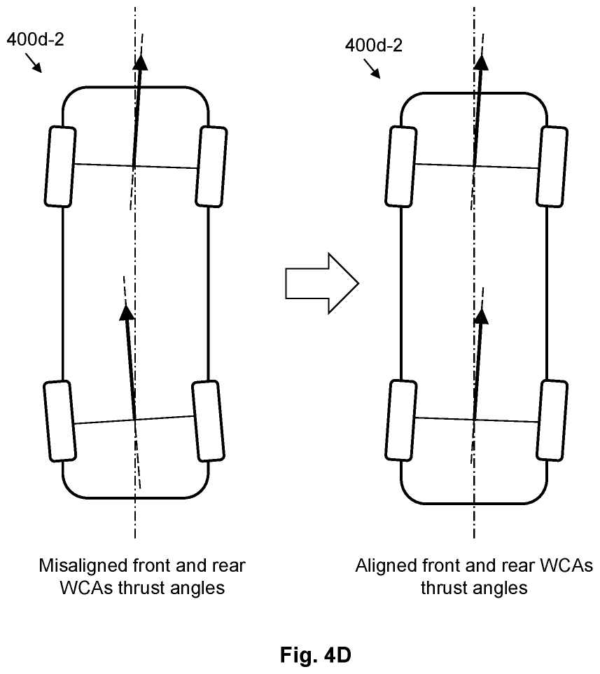

The method may include determining 204 first steering angles of the wheels of the rear WCAs to steer the wheels of the rear WCAs to rotate in planes that are parallel (or substantially parallel) with respect to each other (e.g., as described below with respect to FIGS. 4A, 4B, 4C and 4D).

The method may include determining 206 a thrust angle of the rear WCAs based on the determined first steering angles (e.g., as described below with respect to FIGS. 4A, 4B, 4C and 4D).

The method may include determining 208 second steering angles of the wheels of the front WCAs to steer the wheels of the front WCAs to rotate in planes that are parallel (or substantially parallel) with respect to each other (e.g., as described below with respect to FIGS. 4A, 4B, 4C and 4D).

The method may include determining 210 a thrust angle of the front WCAs based on the determined second steering angles (e.g., as described below with respect to FIGS. 4A, 4B, 4C and 4D).

The method may include controlling 212 the steering actuators associated with at least one of the front WCAs or rear WCAs to steer their respective wheels to align the thrust angle of the front WCAs and the thrust angle of the rear WCAs with respect to each other.

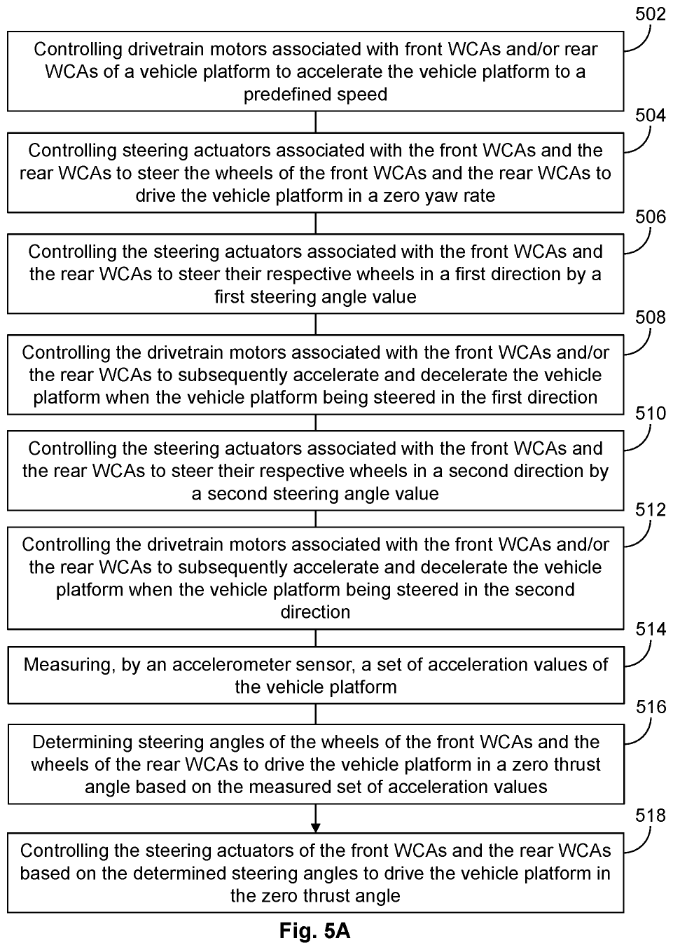

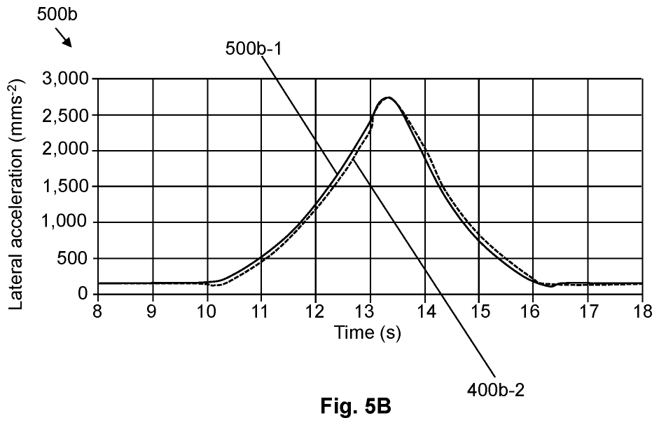

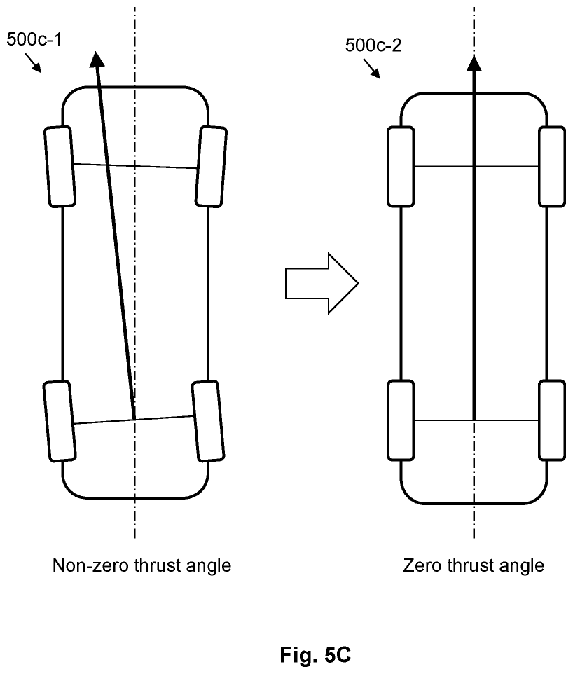

The method may include determining 214 third steering angles of at least one of the wheels of the front WCAs or the wheels of the rear WCAs to drive the vehicle platform in a zero thrust angle (e.g., as described hereinbelow with respect to FIGS. 5A, 5B and 5C).

The method may include controlling 216 the steering actuators associated with at least one of the front WCAs or the rear WCAs based on the determined third steering angles to drive the vehicle platform in the zero thrust angle.

Reference is now made to FIG. 3A, which is a flowchart of a method of automatically aligning WCAs of a vehicle platform to drive the vehicle platform in a zero yaw rate, according to some embodiments of the invention.

The method may be preformed by, for example, one or more of WCA controllers 114, platform controller 130, remote computing device 140, or any combination thereof, as described hereinabove with respect to FIGS. 1A, 1B, 1C and 1D.

The method may include controlling 302 drivetrain motors associated with front WCAs of the vehicle platform to accelerate the vehicle platform to a predefined speed. For example, the vehicle platform may be vehicle platform 100; the front WCAs may be front WCAs 110a; the drivetrain motors may be any of WCA drivetrain motors 113, platform drivetrain motors 122, or any combination thereof; as described hereinabove. The predefined speed may, for example, range between 1-40 km/h, 5-20 km/h, 10-15 km/h, or any other range.

The method may include disabling 304 a zero yaw rate control sub-functionality of a toe control functionality of the vehicle platform.

The method may include controlling 306 steering actuators associated with the front WCAs to steer the wheels of the front WCAs within a predefined steering angles range. For example, the steering actuators may be any of steering actuators 112, 120 described hereinabove. The predefined steering angles range may be, for example, −30° to +30°, −10° to +10°, −5° to +5° with respect to a geometric centerline of the vehicle platform, or any other range. Some embodiments may include controlling the steering actuators to simultaneously steer the wheels of the front WCAs in the same direction.

The method may include measuring 308 (e.g. by wheel hub rotation sensors) rotational speeds of the wheels of the rear WCAs. For example, the rotational speeds of the wheels of the rear WCAs may be measured by wheel hub rotation sensors of sensors 115 of rear WCAs 110b described hereinabove.

The method may include determining 310 steering angles of the wheels of the front WCAs for which the wheels of the rear WCAs rotate at the same rotational speed with respect to each other based on the measured rotational speeds. For example, when the left wheel and the right wheel of the rear WCAs of the vehicle platform rotate at the same rotational speed, the vehicle platform exhibiting the zero yaw rate (e.g., as described below with respect to FIG. 3B).

The method may include controlling 312 the steering actuators associated with the front WCAs based on the determined steering angles to drive the vehicle platform in the zero yaw rate.

Reference is now made to FIG. 3B, which shows a graph 300b of experimental results of utilizing the method of automatically aligning the WCAs of the vehicle platform to drive the vehicle platform in the zero yaw rate, according to some embodiments of the invention.

Solid line 300b-1 in graph 300b represents a variation with time of a difference between rotational speeds of the left wheel and the right wheel of the rear WCAs of the vehicle platform (e.g., in km/h). Dashed line 300b-2 in graph 300b represents a variation with time of the yaw rate of the vehicle platform (e.g., in (degrees/s)/10). When the difference between the rotational speeds of the left wheel and the right wheel of the rear WCAs of the vehicle platform is zero (0), the vehicle platform exhibiting the zero yaw rate (e.g., as shown in FIG. 3B).

Reference is now made to FIG. 3C, which shows schematic illustrations of the vehicle platform exhibiting a non-zero yaw rate and a zero yaw rate, according to some embodiments of the invention.

Illustration 300c-1 shows the vehicle platform exhibiting a non-zero yaw rate. Illustration 300c-2 shows the vehicle platform exhibit a zero yaw rate, for example, upon utilization of the method of automatically aligning the WCAs of the vehicle platform to drive the vehicle platform in the zero yaw rate, as described hereinabove.

Reference is now made to FIG. 4A, which is a flowchart of a method of automatically aligning a thrust angle of front WCAs with a thrust angle of rear WCAs of a vehicle platform, according to some embodiments of the invention.

The method may be preformed by, for example, one or more of WCA controllers 114, platform controller 130, remote computing device 140, or any combination thereof, as described hereinabove with respect to FIGS. 1A, 1B, 1C and 1D.

The method may include controlling 402 drivetrain motors associated with front WCAs and/or rear WCAs of a vehicle platform to accelerate the vehicle platform to a predefined speed. For example, the vehicle platform may be vehicle platform 100; the front WCAs may be front WCAs 110a; the rear WCAs may be rear WCAs 110b; the drivetrain motors may be any of WCA drivetrain motors 113, platform drivetrain motors 122, or any combination thereof; as described hereinabove. The predefined speed may, for example, range between 1-40 km/h, 5-20 km/h, 10-15 km/h, or any other range.

The method may include controlling 404 steering actuators associated with the front WCAs to steer the wheels of the front WCAs to drive the vehicle platform in a zero yaw rate. For example, the computing device may activate the zero yaw rate sub-functionality of the toe control functionality to control the wheels of the first WCAs to drive the vehicle platform in the zero yaw rate. The steering actuators may be WCA steering actuators 112, platform steering actuators 120, or any combination thereof. The steering angles that drive the vehicle platform in the zero yaw rate may be known (e.g., predetermined and provided as an input to a computing device) or may be determined by, for example, the computing device as described hereinabove with respect to FIGS. 3A, 3B and 3C.

The method may include controlling 406 steering actuators associated with the rear WCAs to steer the wheels of the rear WCAs in a predefined steering angles range. For example, the steering actuators may be WCA steering actuators 112, platform steering actuators 120, or any combination thereof. The predefined steering angles range may be, for example, −30° to +30°, −10° to +10°, −5° to +5° with respect to a geometric centerline of the vehicle platform, or any other range. Some embodiments may include controlling the steering actuators associated with the rear WCAs to simultaneously steer the wheels of the rear WCAs in opposite directions with respect to each other.

The method may include measuring 408, by torque sensors, first torque values being applied by the drivetrain motors. For example, the first torque values may be measured by torque sensors of WCA sensors 115 of WCAs 110b described hereinabove.

The method may include determining 410 first steering angles for the wheels of the rear WCAs that cause the drivetrain motors to apply minimal torque values of the measured first torque values.

The method may include determining 412 a thrust angle of the rear WCAs based on the determined first steering angles.

The method may include controlling 414 the steering actuators associated with the rear WCAs to steer the wheels of the rear WCAs to drive the vehicle platform in the zero yaw rate.

The method may include controlling 416 the steering actuators associated with the front WCAs to steer the wheels of the second WCAs in the predefined steering angles range. Some embodiments may include controlling the steering actuators associated with the rear WCAs to simultaneously steer the wheels of the rear WCAs in opposite directions with respect to each other.

The method may include measuring 418, by torque sensors, second torque values being applied by the drivetrain motors.

The method may include determining 420 second steering angles for the wheels of the front WCAs second steering angles for the wheels of the front WCAs that cause the drivetrain motors to apply minimal torque values of the measured second torque values.

The method may include determining 422 a thrust angle of the rear WCAs based on the determined second steering angles.

The method may include controlling 424 the steering actuators associated with at least one of the front WCAs or the rear WCAs to steer their respective wheels to align the thrust angle of the front WCAs and the thrust angle of the rear WCAs with respect to each other.

Minimal torque values being applied by the drivetrain motors may indicate that the wheels of the vehicle platform experiencing minimal drag forces. Minimal drag forces being experienced by the wheels of the vehicle platform may be achieved when, for example, the wheels of the front WCAs rotate in planes that are parallel to each other, when the wheels of the rear WCAs rotate in planes that are parallel to each other and/or when the thrust angle of the front WCAs is aligned with the thrust angle of the rear WCAs.

It is noted that different portions of the method of automatically aligning the thrust angle of the front WCAs with the thrust angle of the rear WCAs of the vehicle platform may be performed in two different rides of the vehicle platform. For example, operations 402-414 and operations 416-428 may be performed in two different rides.

Reference is now made to FIGS. 4B and 4C, which show graphs 400b, 400c of experimental results of utilizing the method of automatically aligning the thrust angle of front WCAs with the thrust angle of rear WCAs of the vehicle platform, according to some embodiments of the invention.

Graph 400b shows curves 400b-1, 400b-2, 400b-3, 400b-4 representing a variation with time of torques being applied by the drivetrain motors associated with the front WCAs and the rear WCAs of the vehicle platform. The drivetrain motors applying substantially same torque values.

Graph 400c shows a curve 400c-1 representing a variation of torque values being applied by one of the drivetrain motors of the vehicle platform with the steering angle of one of the wheels of the second WCAs being steered in the predefined steering angles range. In the example shown in FIG. 4C, the steering angle of the subject wheel that causes the subject drivetrain motor to apply minimal torque values of the measured torque values is 0.38° (e.g., point schematically indicated in FIG. 4C as 400c-2).

Reference is now made to FIG. 4D, which shows schematic illustrations of the vehicle platform exhibiting misaligned front and rear WCAs thrust angles and aligned front and rear WCAs thrust angles, according to some embodiments of the invention.

Illustration 400d-1 shows the vehicle platform exhibiting misaligned front and rear WCAs thrust angles. Illustration 400d-2 shows the vehicle platform exhibit aligned front and rear WCAs thrust angles, for example, upon utilization of the method of automatically aligning the thrust angle of front WCAs with the thrust angle of rear WCAs of the vehicle platform, as described hereinabove.

Reference is now made to FIG. 5A, which is a flowchart of a method of automatically aligning WCAs of a vehicle platform to drive the vehicle platform in a zero thrust angle, according to some embodiments of the invention.

The method may be preformed by, for example, one or more of WCA controllers 114, platform controller 130, remote computing device 140, or any combination thereof, as described hereinabove with respect to FIGS. 1A, 1B, 1C and 1D.

The method may include controlling 502 drivetrain motors associated with front WCAs and/or rear WCAs of a vehicle platform to accelerate the vehicle platform to a predefined speed. For example, the vehicle platform may be vehicle platform 100; the front WCAs may be front WCAs 110a; the rear WCAs may be rear WCAs 110b; the drivetrain motors may be any of WCA drivetrain motors 113, platform drivetrain motors 122, or any combination thereof; as described hereinabove. The predefined speed may, for example, range between 1-40 km/h, 5-20 km/h, 10-15 km/h, or any other range.

The method may include controlling 504 steering actuators associated with the front WCAs and the rear WCAs to steer the wheels of the front WCAs and the rear WCAs to drive the vehicle platform in a zero yaw rate. For example, the computing unit may activate a zero yaw rate sub-functionality of a toe control functionality to control the wheels of the front WCAs and the rear WCAs to drive the vehicle platform in the zero yaw rate. The steering angles that drive the vehicle platform in the zero yaw rate may be determined by, for example, the computing device (e.g., as described hereinabove with respect to FIGS. 4A, 4B and 4C) and/or in any other way known in the art. The steering actuators may be WCA steering actuators 112, platform steering actuators 120, or any combination thereof.

The method may include controlling 506 the steering actuators associated with the front WCAs and the rear WCAs to steer their respective wheels in a first direction by a first steering angle value. For example, the steering actuators may be any of steering actuators 112, 120 described hereinabove. The first steering angle value may be, for example, +2° with respect to, for example, a geometric centerline of the vehicle platform, or any other angle value up to, for example 300.

The method may include controlling 508 the drivetrain motors associated with the front WCAs and/or the rear WCAs to subsequently accelerate and decelerate the vehicle platform when the vehicle platform being steered in the first direction. For example, the vehicle platform may be accelerated, e.g., at an acceleration of 3 m/s², from the predefined speed of 10 km/h to 50 km/h and further decelerated, e.g., at a deceleration of 3 m/s², from 50 km/h to 10 km/h.

The method may include controlling 510 the steering actuators associated with the front WCAs and the rear WCAs to steer their respective wheels in a second direction by a second steering angle value. The second steering angle value may be, for example, −4° with respect to the first steering angle value of +2°, or −2° with respect to the geometric centerline of the vehicle platform, or any other angle value up to, for example, −30°.

The method may include controlling 512 the drivetrain motors associated with the front WCAs and/or the rear WCAs to subsequently accelerate and decelerate the vehicle platform when the vehicle platform being steered in the second direction. For example, the vehicle platform may be accelerated, e.g., at an acceleration of 3 m/s² (or any other acceleration value), from the predefined speed of 10 km/h to, for example 50 km/h (or any other speed value) and further decelerated, e.g., at a deceleration of 3 m/s² (or any other deceleration value), from 50 km/h to 10 km/h.

Some embodiments may include measuring, by yaw/steering angle sensors, steering angles of the front WCAs and the rear WCAs when the vehicle platform is at the predefined speed and when the front WCAs and the rear WCAs being toe controlled by the computing device (e.g., in operations 502 and 504 described hereinabove). Some embodiments may include determining mean yaw/steering angles values based on the measured yaw/steering angle values. Some embodiments may include determining the first steering angle value and the second steering angle value based on the mean yaw/steering angles values.

The method may include measuring 514, by an accelerometer sensor, a set of acceleration values of the vehicle platform.

The method may include determining 516 steering angles of the wheels of the front WCAs and the wheels of the rear WCAs to drive the vehicle platform in a zero thrust angle based on the measured set of acceleration values.

The method may include controlling 518 the steering actuators of the front WCAs and the rear WCAs based on the determined steering angles to drive the vehicle platform in the zero thrust angle.

If the wheels of the front WCAs and/or the rear WCAs are not aligned, longitudinal acceleration of the vehicle platform (e.g., like in operations 508 and 512 described hereinabove) may cause different measured lateral acceleration values of the vehicle platform when the vehicle platform being steered in the first direction and the second direction. The differences in measured lateral acceleration values may be indicative of a non-zero thrust angle of the vehicle platform. The steering angles of the wheels of the front WCAs and the wheels of the rear WCAs that cause the vehicle platform to drive in the zero thrust angle may be determined based on the differences in the measured lateral acceleration values.

Reference is now made to FIG. 5B, which shows a graph 500b of experimental results of utilizing the method of automatically aligning the WCAs of the vehicle platform to drive the vehicle platform in the zero thrust angle, according to some embodiments of the invention.

Curve 500b-1 in graph 500b shows a variation with time of the measured lateral acceleration values when the vehicle platform has been steered in the first direction. Curve 500b-2 in graph 500b shows a variation with time of the measured lateral acceleration values when the vehicle platform has been steered in the second direction. The differences between curves 500b-1, 500b-2 may be due to a non-zero thrust angle of the vehicle platform.

Reference is now made to FIG. 5C, which shows schematic illustrations of the vehicle platform exhibiting a non-zero thrust angle and a zero thrust angle, according to some embodiments of the invention.

Illustration 500c-1 shows the vehicle platform exhibiting a thrust angle. Illustration 400c-2 shows the vehicle platform exhibit a zero thrust angle, for example, upon utilization of the method of automatically aligning the WCAs of the vehicle platform to drive the vehicle platform in the zero thrust angle, as described hereinabove.

An advantage of the present invention may include automatic alignment of WCAs of a vehicle platform being performed by a computing device of the vehicle platform in one or more rides on a flat (or substantially flat) surface while eliminating a need in dedicated wheel alignment systems.

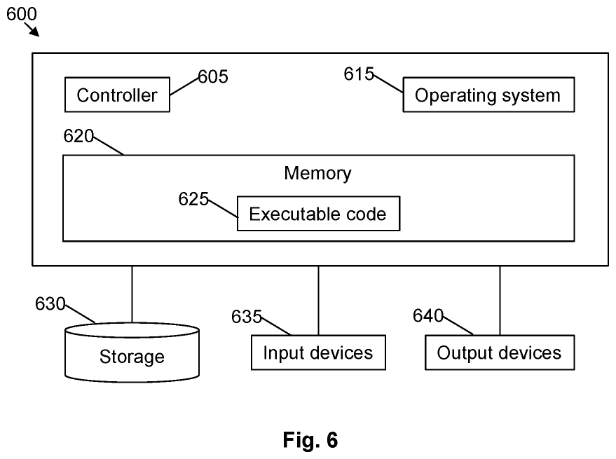

Reference is now made to FIG. 6, which is a block diagram of an exemplary computing device which may be used with embodiments of the present invention.

Computing device 600 may include a controller or processor 605 that may be, for example, a central processing unit processor (CPU), a chip or any suitable computing or computational device, an operating system 615, a memory 620, a storage 630, input devices 635 and output devices 640.

Operating system 615 may be or may include any code segment designed and/or configured to perform tasks involving coordination, scheduling, arbitration, supervising, controlling or otherwise managing operation of computing device 600, for example, scheduling execution of programs. Memory 620 may be or may include, for example, a Random Access Memory (RAM), a read only memory (ROM), a Dynamic RAM (DRAM), a Synchronous DRAM (SD-RAM), a double data rate (DDR) memory chip, a Flash memory, a volatile memory, a non-volatile memory, a cache memory, a buffer, a short term memory unit, a long term memory unit, or other suitable memory units or storage units. Memory 620 may be or may include a plurality of, possibly different, memory units. Memory 620 may store for example, instructions to carry out a method (e.g., code 625), and/or data such as user responses, interruptions, etc.

Executable code 625 may be any executable code, e.g., an application, a program, a process, task or script. Executable code 625 may be executed by controller 605 possibly under control of operating system 615. In some embodiments, more than one computing device 600 or components of device 600 may be used for multiple functions described herein. For the various modules and functions described herein, one or more computing devices 600 or components of computing device 600 may be used. Devices that include components similar or different to those included in computing device 600 may be used, and may be connected to a network and used as a system. One or more processor(s) 605 may be configured to carry out embodiments of the present invention by for example executing software or code. Storage 630 may be or may include, for example, a hard disk drive, a floppy disk drive, a Compact Disk (CD) drive, a CD-Recordable (CD-R) drive, a universal serial bus (USB) device or other suitable removable and/or fixed storage unit. In some embodiments, some of the components shown in FIG. 1 may be omitted.

Input devices 635 may be or may include a mouse, a keyboard, a touch screen or pad or any suitable input device. It will be recognized that any suitable number of input devices may be operatively connected to computing device 600 as shown by block 635. Output devices 640 may include one or more displays, speakers and/or any other suitable output devices. It will be recognized that any suitable number of output devices may be operatively connected to computing device 600 as shown by block 640. Any applicable input/output (I/O) devices may be connected to computing device 600, for example, a wired or wireless network interface card (NIC), a modem, printer or facsimile machine, a universal serial bus (USB) device or external hard drive may be included in input devices 635 and/or output devices 640.

Embodiments of the invention may include one or more article(s) (e.g., memory 620 or storage 630) such as a computer or processor non-transitory readable medium, or a computer or processor non-transitory storage medium, such as for example a memory, a disk drive, or a USB flash memory, encoding, including or storing instructions, e.g., computer-executable instructions, which, when executed by a processor or controller, carry out methods disclosed herein.

In the above description, an embodiment is an example or implementation of the invention. The various appearances of “one embodiment”, “an embodiment”, “certain embodiments” or “some embodiments” do not necessarily all refer to the same embodiments. Although various features of the invention can be described in the context of a single embodiment, the features can also be provided separately or in any suitable combination. Conversely, although the invention can be described herein in the context of separate embodiments for clarity, the invention can also be implemented in a single embodiment. Certain embodiments of the invention can include features from different embodiments disclosed above, and certain embodiments can incorporate elements from other embodiments disclosed above. The disclosure of elements of the invention in the context of a specific embodiment is not to be taken as limiting their use in the specific embodiment alone. Furthermore, it is to be understood that the invention can be carried out or practiced in various ways and that the invention can be implemented in certain embodiments other than the ones outlined in the description above.

The invention is not limited to those diagrams or to the corresponding descriptions. For example, flow need not move through each illustrated box or state, or in exactly the same order as illustrated and described. Meanings of technical and scientific terms used herein are to be commonly understood as by one of ordinary skill in the art to which the invention belongs, unless otherwise defined. While the invention has been described with respect to a limited number of embodiments, these should not be construed as limitations on the scope of the invention, but rather as exemplifications of some of the preferred embodiments. Other possible variations, modifications, and applications are also within the scope of the invention. Accordingly, the scope of the invention should not be limited by what has thus far been described, but by the appended claims and their legal equivalents.

1. A method of automatically aligning wheel corner assemblies (WCAs) of a vehicle platform having front WCAs, rear WCAs, and steering actuators coupled to the front WCAs and rear WCAs, wherein each of the front WCAs and each of the rear WCAs comprises a wheel, the method comprising:
measuring, by sensors of at least one of the front WCAs, the rear WCAs, the vehicle platform, or any combination thereof, a set of parameters;
determining, by a computing device, steering angles for the wheels of the front WCAs and the wheels of the rear WCAs to drive the vehicle platform in at least one of a zero yaw rate or a zero thrust angle based on the measured set of parameters; and
controlling, by the computing device, the steering actuators of the front WCAs and the steering actuators of the rear WCAs based on the determined steering angles to drive the vehicle platform in at least one of the zero yaw rate or the zero thrust angle.

2. The method of claim 1, comprising controlling, by the computing device, the steering actuators associated with at least one of the front WCAs or the rear WCAs of the vehicle platform to steer their respective wheels according to a predefined protocol.

3. The method of claim 1, wherein the determining the steering angles to drive the vehicle platform in the zero yaw rate comprising:
controlling, by the computing device, drivetrain motors associated with the front WCAs of the vehicle platform to accelerate the vehicle platform to a predefined speed;
controlling, by the computing device, the steering actuators associated with the front WCAs to steer the wheels of the front WCAs within a predefined steering angles range;
measuring rotational speeds of the wheels of the rear WCAs;
determining, by the computing device, steering angles of the wheels of the front WCAs for which the wheels of the rear WCAs rotate at the same rotational speed with respect to each other based on the measured rotational speeds; and
controlling, by the computing device, the steering actuators associated with the front WCAs based on the determined steering angles to drive the vehicle platform in the zero yaw rate.

4. The method of claim 1, further comprising disabling, by the computing device, a zero yaw rate control sub-functionality of a toe control functionality of the vehicle platform.

5. The method of claim 1, further comprising controlling, by the computing device, the steering actuators to simultaneously steer the wheels of the front WCAs in the same direction.

6. The method of claim 1, further comprising:
determining, by the computing device, steering angles of at least one of the wheels of the front WCAs or the wheels of the rear WCAs for which a thrust angle of the front WCAs and a thrust angle of the rear WCAs being aligned with respect to each other; and
controlling, by the computing device, the steering actuators associated with at least one of the front WCAs or the rear WCAs based on the determined steering angles to align the thrust angle of the front WCAs and the thrust angle of the rear WCAs.

7. The method of claim 6, wherein the determining the steering angles to align the thrust angle of the front WCAs and the thrust angle of the rear WCAs with respect to each other comprising:
controlling, by the computing device, drivetrain motors associated with at least one of the front WCAs or the rear WCAs to accelerate the vehicle platform to a predefined speed;
controlling, by the computing device, the steering actuators associated with the front WCAs to steer the wheels of the front WCAs to drive the vehicle platform in the zero yaw rate;
controlling, by the computing device, the steering actuators associated with the rear WCAs to steer the wheels of the rear WCAs in a predefined steering angles range;
measuring, by torque sensors, first torque values being applied by the drivetrain motors;
determining, by the computing device, first steering angles for the wheels of the rear WCAs that cause the drivetrain motors to apply minimal torque values of the measured first torque values;
determining, by the computing device, a thrust angle of the rear WCAs based on the determined first steering angles.

8. The method of claim 7, further comprising controlling, by the computing device, the steering actuators associated with the rear WCAs to simultaneously steer the wheels of the rear WCAs in opposite directions with respect to each other.

9. The method of claim 7, further comprising:
controlling, by the computing device, the steering actuators associated with the rear WCAs to steer the wheels of the rear WCAs to drive the vehicle platform in the zero yaw rate;
controlling, by the computing device, the steering actuators associated with the front WCAs to steer the wheels of the second WCAs in the predefined steering angles range;
measuring, by torque sensors, second torque values being applied by the drivetrain motors;
determining, by the computing device, second steering angles for the wheels of the front WCAs that cause the drivetrain motors to apply minimal torque values of the measured second torque values;
determining, by the computing device, a thrust angle of the rear WCAs based on the determined second steering angles; and
controlling, by the computing device, the steering actuators associated with at least one of the front WCAs or the rear WCAs to steer their respective wheels to align the thrust angle of the front WCAs and the thrust angle of the rear WCAs with respect to each other.

10. The method of claim 9, further comprising controlling, by the computing device, the steering actuators associated with the front WCAs to simultaneously steer the wheels of the front WCAs in opposite directions with respect to each other.

11. The method of claim 1, wherein determining the steering angles to drive the vehicle platform in the zero thrust angle comprising:
controlling, by the computing device, drivetrain motors associated with at least one of the front WCAs or the rear WCAs to accelerate the vehicle platform to a predefined speed;
controlling, by the computing device, the steering actuators associated with the front WCAs and the rear WCAs to steer the wheels of the front WCAs and the rear WCAs to drive the vehicle platform in the zero yaw rate;
controlling, by the computing device, the steering actuators associated with the front WCAs and the rear WCAs to steer their respective wheels in a first direction by a first steering angle value;
controlling, by the computing device, the drivetrain motors associated with at least one of the front WCAs or the rear WCAs to subsequently accelerate and decelerate the vehicle platform when the vehicle platform being steered in the first direction;
controlling, by the computing device, the steering actuators associated with the front WCAs and the rear WCAs to steer their respective wheels in a second direction by a second steering angle value;
controlling, by the computing device, the drivetrain motors associated with at least one of the front WCAs or the rear WCAs to subsequently accelerate and decelerate the vehicle platform when the vehicle platform being steered in the first direction;
measuring, by an accelerometer sensor, a set of acceleration values of the vehicle platform; and
determining, by the computing device, steering angles of the wheels of the front WCAs and the wheels of the rear WCAs to drive the vehicle platform in the zero thrust angle based on the measured set of acceleration values.

12. The method of claim 11, further comprising:
measuring, by steering angle sensors, steering angles of the front WCAs and the rear WCAs when the vehicle platform is at the predefined speed and when the front WCAs and the rear WCAs being toe controlled by the computing device;
determining, by the computing device, mean steering angles values based on the measured steering angle values; and
determining, by the computing device, the first steering angle value and the second steering angle value based on the mean steering angles values.

13. The method of claim 11, wherein the measured acceleration values comprise lateral acceleration values.

14. The method of claim 1, wherein the computing device is disposed on the vehicle platform.

15. A method of automatically aligning wheel corner assemblies (WCAs) of a vehicle platform having front WCAs, rear WCAs, and steering actuators coupled to the front WCAs and rear WCAs, wherein each of the front WCAs and each of the rear WCAs comprises a wheel, the method comprising:
controlling, by a computing device, the steering actuators associated with at least one of the front WCAs or the rear WCAs of the vehicle platform to steer their respective wheels to drive the vehicle platform in a zero yaw rate;
determining, by the computing device, first steering angles of the wheels of the rear WCAs to steer the rear WCAs to rotate in planes that are parallel with respect to each other;
determining, by the computing device, a thrust angle of the rear WCAs based on the determined first steering angles;
determining, by the computing device, second steering angles of the wheels of the front WCAs to steer the wheels of the front WCAs to rotate in planes that are parallel with respect to each other;
determining, by the computing device, a thrust angle of the front WCAs based on the determined second steering angles;
controlling, by the computing device, the steering actuators associated with at least one of the front WCAs or the rear WCAs to steer their respective wheels to align the thrust angle of the front WCAs and the thrust angle of the rear WCAs with respect to each other;
determining, by the computing device, third steering angles of the wheels of the front WCAs and the wheels of the rear WCAs to drive the vehicle platform in a zero thrust angle; and
controlling, by the computing device, the steering actuators associated with at least one of the front WCAs or the rear WCAs based on the determined third steering angles to drive the vehicle platform in the zero thrust angle.

16. The method of claim 15, further comprising determining steering angles of at least one of the wheels of the front WCAs or the wheels of the rear WCAs to drive the vehicle platform in the zero yaw rate.

17. The method of claim 16, wherein determining the steering angles to drive the vehicle platform in the zero yaw rate comprising:
controlling, by the computing device, drivetrain motors associated with the front WCAs of the vehicle platform to accelerate the vehicle platform to a predefined speed;
controlling, by the computing device, the steering actuators associated with the front WCAs to steer the wheels of the front WCAs within a predefined steering angles range;
measuring rotational speeds of the wheels of the rear WCAs;
determining, by the computing device, the steering angles of the wheels of the front WCAs for which the wheels of the rear WCAs rotate at the same rotational speed with respect to each other based on the measured rotational speeds; and
controlling, by the computing device, the steering actuators associated with the front WCAs based on the determined steering angles to drive the vehicle platform in the zero yaw rate.

18. The method of claim 17, further comprising disabling, by the computing device, a zero yaw rate control sub-functionality of a toe control functionality of the vehicle platform.

19. The method of claim 17, further comprising controlling, by the computing device, the steering actuators to simultaneously steer the wheels of the front WCAs in the same direction.

20. The method of claim 15, wherein determining the first steering angles to steer the wheels of the front WCAs to rotate in planes that are parallel with respect to each other comprising:
controlling, by the computing device, drivetrain motors associated with at least one of the front WCAs or the rear WCAs to accelerate the vehicle platform to a predefined speed;
controlling, by the computing device, the steering actuators associated with the front WCAs to steer the wheels of the front WCAs to drive the vehicle platform in the zero yaw rate;
controlling, by the computing device, the steering actuators associated with the rear WCAs to steer the wheels of the rear WCAs in a predefined steering angles range;
measuring, by torque sensors, first torque values being applied by the drivetrain motors;
determining, by the computing device, first steering angles for the wheels of the rear WCAs that cause the drivetrain motors to apply minimal torque values of the measured first torque values;
determining, by the computing device, a thrust angle of the rear WCAs based on the determined first steering angles.

21. The method of claim 20, further comprising controlling, by the computing device, the steering actuators associated with the rear WCAs to simultaneously steer the wheels of the rear WCAs in opposite directions with respect to each other.

22-37. (canceled)
